(19) United States
(12) Patent Application Publication
(10) Pub. No.: US 2017/0183133 A1
(43) Pub. Date: Jun. 29, 2017

(54) CHILD RESISTANT CHEMICAL PACKAGING DEVICE

(71) Applicant: Arch Chemicals Inc., Allendale, NJ (US)

(72) Inventor: Frederick Simonsen, Alpharetta (GA)

(21) Appl. No.: 15/391,972

(22) Filed: Dec. 28, 2016

Related U.S. Application Data
(60) Provisional application No. 62/271,876, filed on Dec. 28, 2015.

(51) Int. Cl. B65D 50/06; C02F 1/68; B65B 7/28; B65D 43/16; B65D 25/32

(52) U.S. Cl. CPC B65D 50/06; B65D 43/161; B65D 25/32; B65B 7/28; C02F 1/68; C02F 2103/42

(57) ABSTRACT

Disclosed herein are devices, systems, and methods relating to storing hazardous chemicals without the use of secondary, child resistant packaging. One such chemical packaging system can include a lightweight, non-cylindrical container having a bottom, a side wall, an opening, and an enclosure having a child resistant lock configured to selectively secure the enclosure to the container such that the container can be selectively opened, and a hazardous chemical that is free of child resistant packaging disposed within the lightweight container.

### CROSS-REFERENCE TO RELATED APPLICATION

This application claims priority under 35 U.S.C. §119(e) from Provisional Application No. 62/271,876 filed Dec. 28, 2015, which is herein incorporated by reference.

### BACKGROUND

The present disclosure relates to chemical containers, and more specifically, to lightweight pool chemical containers having a child resistant lock.

Many chemicals, such as swimming pool and spa chemicals and other hazardous chemicals, are packaged and sold to consumers in residential and light commercial settings—i.e., pool owners and/or home owners. As a result, containers storing chemicals often are stored in areas where improper storage and handling is of relatively high risk, such as those frequented by children. As such, chemical containers are often required by rules and regulations to contain child resistant packaging and/or child resistant locks.

In addition to child resistant packaging requirements, chemical containers must meet various standards for shipping and storage. The United Nations (“UN”) and Federal Department of Transportation (“DOT”) tests containers to be certain that if such a container is dropped it will not burst open. These UN and DOT test procedures and regulations are currently based on the United Nations Recommendations of the Committee of Experts on the Transport of Dangerous Goods. They require, in part, that chemical containers be subjected to “drop tests” from various heights to insure that the contents of the container are not ejected when the container is dropped on its weakest point. Typically, this requires that the container be dropped from a height of between about two and six feet, depending on the type of material that is to be carried in the container.

In order to provide child resistant protections and meet these UN and DOT standards, chemical containers either employ a heavy-duty container or utilize secondary packaging on the interior of the container. For example, containers often employ a child resistant lock—open and reclose feature—on the exterior of a large, heavy-duty container. These containers are typically larger than 2 gallons in volume and are often 5, 8, or 10 gallon pails or buckets. When smaller-volume containers are desired, however, these rugged, heavy-duty large packages cannot simply be scaled down to accommodate lower shipping volumes as scaling down a heavy-duty container will result in an inefficient usage of material.

Small-volume, lightweight containers such as modular pails having a volume that is less than about 2 gallons suffer, however, as these containers will often not pass UN or DOT testing on their own and typically do not have child resistant mechanisms on the exterior of the container. There currently are no non-cylindrical modular pails smaller than about 2 gallons certified for child resistance. As such, small-volume containers are typically provided with the chemical individually packaged in separate, secondary packaging, such as a child resistant film or bag on the interior of the chemical container. Other forms of secondary packaging include spill-safe membranes, bags, and liners. Often, the secondary packaging is a child resistant wrapper film made of a cross-laminated polyethylene film construction, such as that marketed by Valeron®. This film is used to individually wrap solid (dry or non-liquid) chemical products such as granules, discs, briquettes, sticks, pellets, and/or water soluble pods that may contain granular, other solid, liquid, or a combination of forms within the water soluble pod. While providing effective child resistance, lightweight containers that have secondary packaging on the interior of the container increase the materials required to properly store chemicals and ultimately increase the handling time and cost and waste produced in the use and manufacture of chemicals.

Chemicals are also stored in cylindrical containers. These cylindrical containers, however, are inefficiently stored as the circular cross-section of the cylinder results in large interstitial spaces between containers. As such, containers having a cylindrical cross-section result in increased storage and production costs and result in wasted shipping materials and resources.

As such, a lightweight, non-cylindrical shipping container is desired that does not require child resistant and/or secondary packaging on the interior of the container.

### SUMMARY

A lightweight pool chemical packaging device is disclosed herein. The lightweight pool chemical packaging device can include a non-cylindrical container having a bottom, a side wall, and an opening, and an enclosure having a child resistant lock configured to selectively secure the enclosure to the container such that the container can be selectively opened. The device also includes a pool chemical that is free of child resistant packaging disposed within the container.

As will be described herein, in some aspects, the side wall has a gauge that is between about 50 mil and about 15 mil and/or the bottom can have a gauge that is between about 50 mil and about 15 mil. In some aspects, the container has a volume between about one-half (0.5) gallon and about 2 gallons. The child resistant lock—in some aspects—can include an interlocking component that is configured to mate with a corresponding interlocking component of the container. Additionally, in some aspects, a portion of the child resistant lock is disposed on the enclosure and a portion of the child resistant lock is disposed on the container. In other aspects, the enclosure further includes a first flap, a second flap, and a hinge separating the first and second flap.

In some aspects, the pool chemical can be free of secondary packaging within the container. Additionally, the pool chemical can be calcium hypochlorite, dichloro-s-triazinetrione, trichloro-s-triazinetrione, or polyhexamethylene biguanide. Further, in some aspects, the pool chemical is a tablet, disk, stick, briquette, or inner unitized package.

Also disclosed herein is a chemical packaging system that includes a lightweight, non-cylindrical container having a bottom, a side wall, an opening, and an enclosure having a child resistant lock configured to selectively secure the enclosure to the container such that the container can be selectively opened, and a hazardous chemical that is free of child resistant packaging disposed within the lightweight container.

As will be described herein, in some aspects, the side wall has a gauge that is between about 50 mil and 15 mil and/or the bottom can have a gauge that is between about 50 mil and 15 mil. In some aspects, the container has a volume between about one-half (0.5) gallon and about 2 gallons. The child resistant lock—in some aspects—can include an interlocking component that is configured to mate with a corresponding interlocking component of the container. In other aspects, the enclosure further includes a first flap, a second flap, and a hinge separating the first and second flap. In some aspects, the hazardous chemical can be a pool chemical.

Also disclosed herein is a method of packaging a hazardous chemical that includes filling a non-cylindrical container having a bottom, a side wall, and an opening with a hazardous chemical that is free of child resistant packaging within the container, and enclosing the opening of the container with an enclosure having a child resistant lock configured to selectively secure the enclosure to the container such that the container can be selectively opened. Further, in some aspects, the hazardous chemical is a tablet, disk, stick, briquette, or inner unitized package of various sizes and shapes.

In some aspects, the hazardous chemical is a pool chemical. Additionally, the pool chemical can be calcium hypochlorite, dichloro-s-triazinetrione, trichloro-s-triazinetrione, or polyhexamethylene biguanide. Further, in some aspects, the side wall of the container has a gauge that is about 50 mil or less and/or the bottom of the container can have a gauge that is about 50 mil or less. In some aspects, the container has a volume between about one-half gallon and about 2 gallons.

### BRIEF DESCRIPTION OF THE DRAWINGS

This disclosure will be more fully understood from the following detailed description taken in conjunction with the accompanying drawings, in which:

FIG. 1 is a perspective view of a packaging device;

FIG. 2 is a top down view of a packaging device;

FIG. 3 is a perspective view of a packaging device;

FIG. 4 is a side view of a container;

FIG. 5 is a side view of a container;

FIG. 6 is a top-down view of an enclosure;

FIG. 7 is a top-down view of an enclosure;

FIG. 8 is a top-down view of an enclosure;

FIG. 9 is a top-down view of an enclosure;

FIG. 10 is a perspective view of an enclosure;

FIG. 11 is a perspective view of a child resistant lock; and

FIG. 12 is a top-down view of a container with a chemical having no secondary packaging disposed within the container.

### DETAILED DESCRIPTION

As stated above, the present disclosure relates to chemical containers, which are now described in detail with accompanying figures. It is noted that like reference numerals refer to like elements across different embodiments.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

Chemicals, including hazardous chemicals such as pool chemicals, often require the usage of child resistant packaging and packaging that will pass certain drop tests required by various rules and regulations. Additionally and as described above, small-volume containers that meet these requirements suffer from significant material waste and added complexity during filling and manufacture. As will be described in more detail below, the devices, systems, and methods described herein overcome these material wastes and complex filling and manufacturing methods due in part to the elimination of child resistant packaging, and in some aspects any and all secondary packaging, on the interior of chemical storage containers. As used herein, “secondary packaging” means any packaging that is additional to an external packaging container and is disposed on an interior of the external packaging container and can include films, bags, membranes, or liners placed inside a container. Secondary packaging can include individual wrapping—such as a child resistant bag or film—around a chemical product. Secondary packaging may contain single tablets, briquettes, discs, sticks or pouches of granular and/or the secondary packaging may also include multiple tablets, briquettes, discs, sticks or pouches. In some aspects, secondary packaging may be reclosable with CR/SF certified packaging as, in some circumstances, multiple access child resistant and senior friendly packages can be intended to be opened and reopened multiple times, providing CR and SF during consumption of the package contents.

In some aspects, the devices, systems, and methods disclosed herein can be used to store and contain any hazardous chemical. Example hazardous chemicals include detergents and cleaning agents, dyes, acids, pharmaceuticals, and water treatment chemicals. In some aspects, hazardous chemicals may be an inner unitized package such as a pod in a water soluble film. In some such aspects, the devices, systems, and methods disclosed herein are used to store and contain pool chemicals. As used herein, a “pool chemical” is a chemical that is formulated for the purpose of treating recreational bathing water and can include chemicals typically used to treat pools, spas, fountains, and any other recreational bathing water system. Such pool chemical or chemicals include but are not limited to various formulations of calcium hypochlorite, dichloro-s-triazinetrione, trichloro-s-triazinetrione, polyhexamethylene biguanide, algaecides such as copper alagaecide, or other similar chemical. Moreover, “pool chemicals,” as used herein, can include any form of chemical, which may include solid formulations. For example, in some aspects, granule, pellet, tablet, disk, and/or briquette formulations are contemplated.

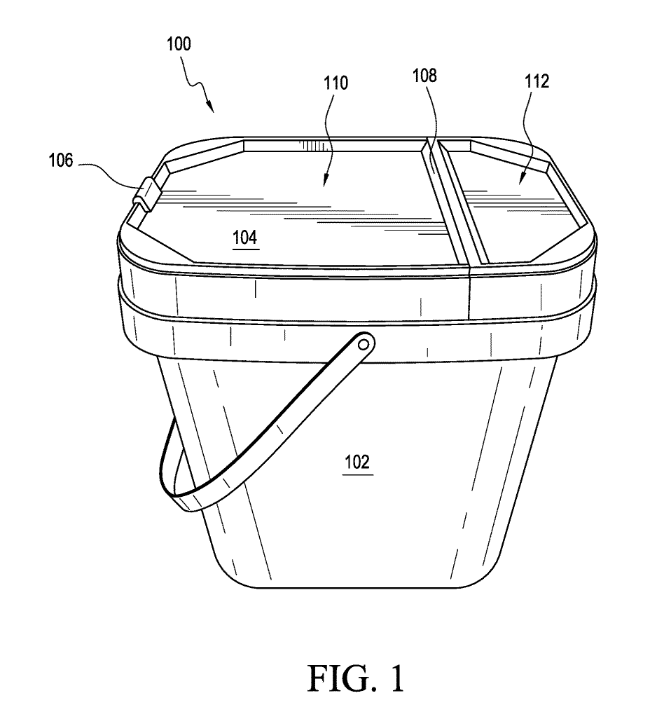

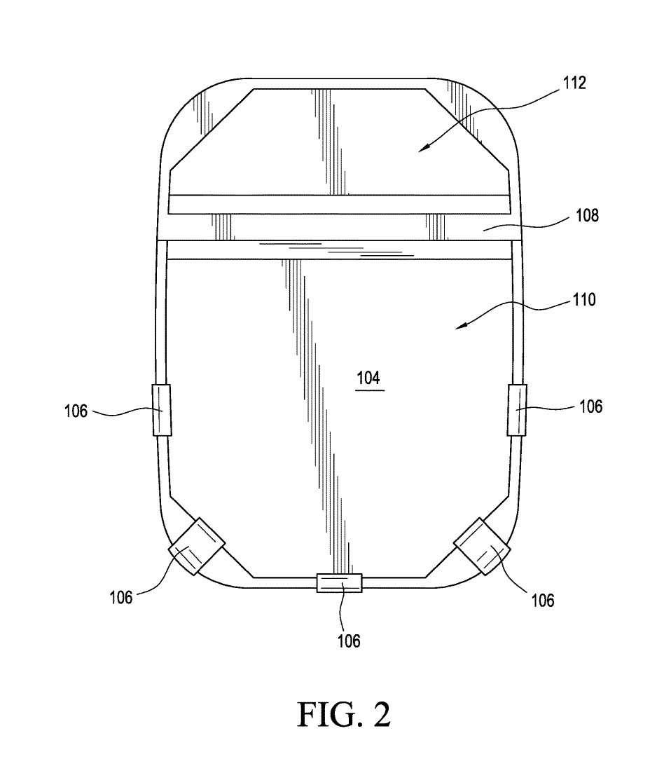

FIGS. 1 and 2 illustrate an example lightweight pool chemical packaging device 100. FIG. 1 is a perspective view of a packaging device 100. FIG. 2 is a top down view of a packaging device 100. As shown, the lightweight pool chemical packaging device 100 includes a container 102 and an enclosure 104. The enclosure 104 includes a child resistant mechanism or lock 106. Also, in some aspects such as that shown in FIG. 1, the enclosure 104 can include a hinge 108 that is configured to moveably couple a first flap 110 to a second flap 112. As such, in some aspects, the second flap 112 can be permanently secured to the container 102 while the first flap 110 is selectively secured to the container 102 using the child resistant lock 106 allowing a portion of the opening in the container to be selectively accessed.

The container 102 can be any suitable non-cylindrical container. As used herein, “non-cylindrical” means any shape that does not have a radial dimension across an axial cross-section such that the container is not substantially circular in cross-section. Such non-cylindrical shapes can include containers with rectangular axial cross-sections such as cubes, as well as triangular, pentagonal, and/or hexagonal axial cross-sections, among others. As described in U.S. Pat. No. 8,056,758, which is hereby incorporated by reference in its entirety, non-cylindrical containers can have rounded corners, sides, and other rounded features so long as the cross-sectional area is not substantially circular. Although even containers having cross sectional shapes such a rectangles, can have rounded corners, the radius of the corner is usually smaller than the radius of a cylindrical container having a similar capacity. In some aspects, illustrative corner radii ranges of at least one sidewall-to-sidewall intersection can include, about 2 inches or less or about 1.5 inches or less. In some aspects, illustrative corner radii ranges can include about 0.5 inches to about 2.5 inches; about 1.0 inch to about 2.0 inches; and about 1.25 inches to about 1.75 inches.

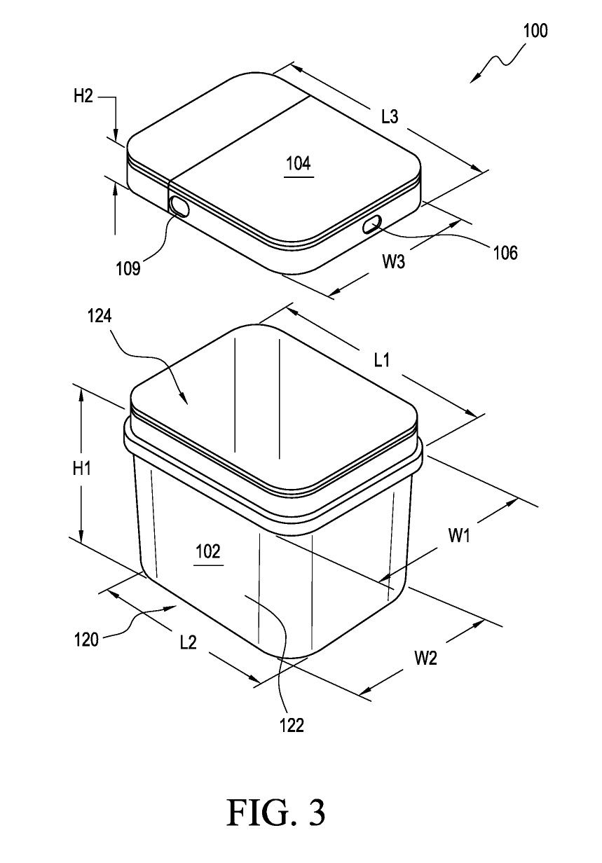

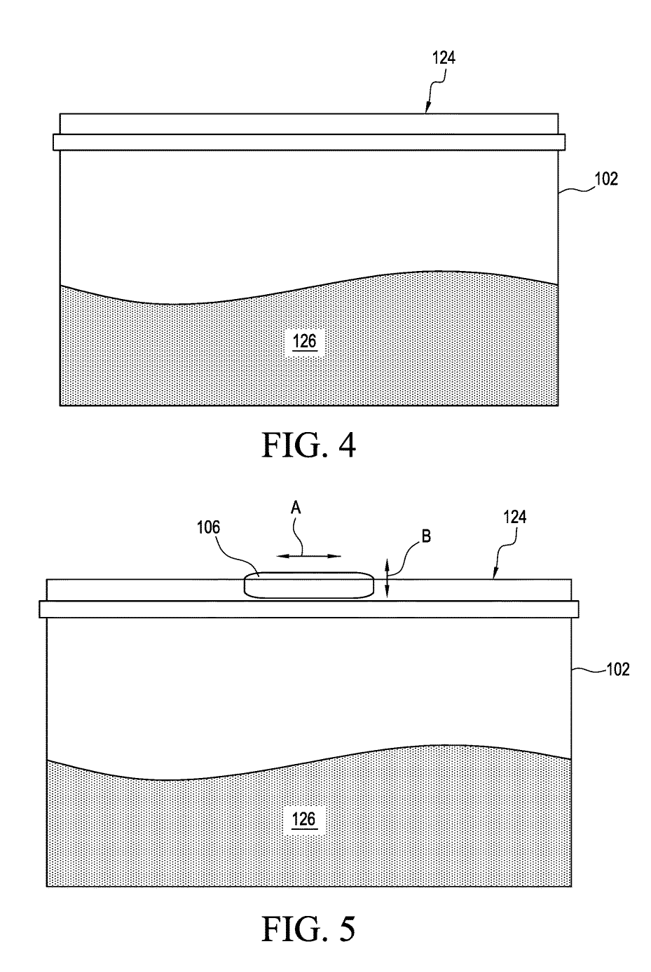

For example, FIGS. 1-5, illustrate non-cylindrical containers 102 of various dimensions. FIG. 3 is a perspective view of an example device 100. FIG. 4 is a side view of an example container 102. FIG. 5 is a side view of an example container 102. As shown, in some non-limiting aspects, the container 102 can be substantially rectangular in shape and can have a bottom 120, a side wall 122, and an opening 124 and contain a pool chemical 126. It is noted that with reference to FIGS. 4 and 5, the pool chemical 126 is not necessarily visible through a side of the container 102 but is shown in this manner for illustrative purposes only.

The container 102 can have any suitable dimensions. Referring to FIG. 3, the container 102 can have a height H1, a length L1 at the top of the container and a length L2 at the bottom of the container, and a width W1 at the top of the container and a width W2 at the bottom of the container. In some aspects, the dimensions L1, L2, H1, W1, and W2 can be any suitable dimension to provide a small-volume modular container or pail. For example, the dimensions can be sufficient, in some aspects, to provide a container having a volume of about 2 gallons or less. For example, the dimensions can be sufficient, in some aspects, to provide a container having a volume of about 2 gallons, about 1.6 gallons, about 1.3 gallons, about 1 gallon, about 0.75 gallons, about 0.6 gallons, and about 0.5 gallons. In some aspects, the small-volume container 102 has a volume of between about one-half (0.5) gallons and about 2 gallons. In some aspects, the container 102 can have a length L1 of between about 6¾ inches and about 10 inches, a length L2 of between about 6 inches and about 9 inches, a height H1 of between about 5 inches and about 11 inches, a width W1 of between about 5½ inches and 8 inches, and a width W2 of between about 4¾ inches and 6½ inches.

Furthermore, the container 102 can have any suitable thickness or gauge such that the container is a lightweight container that minimizes excess materials used in the production of the container. In some aspects, for example, the side wall 122 and/or bottom 120 of the container 102 can have a gauge of about 65 mil or less. In some aspects, the side wall 122 and/or bottom 120 of the container 102 can have a gauge of between about 50 mil and about 15 mil. In some aspects, the side wall 122 and/or bottom 120 of the container 102 can have a gauge of about 25 mil, about 30 mil, about 35 mil, about 40 mil, about 45 mil, and/or about 50 mil. Expressed alternatively as a thickness, the side wall 122 and/or bottom 120 of the container 102 can have a thickness of between about 0.75 millimeters (mm) to about 2 millimeters (mm). In some aspects, the side wall 122 and/or bottom 120 of the container 102 can have a thickness of between about 0.79 millimeters (mm) to about 1.8 millimeters (mm). For example, in some aspects, a 0.75 gallon container can have a side wall 122 and/or bottom 120 with a thickness of between about 0.79 millimeters (mm) and about 0.90 millimeters (mm). For example, in some aspects, a 1.0 gallon container can have a side wall 122 and/or bottom 120 with a thickness of between about 0.94 millimeters (mm) and about 1.1 millimeters (mm). For example, in some aspects, a 1.3 gallon or a 1.6 gallon container can have a side wall 122 and/or bottom 120 with a thickness of between about 1.1 millimeters (mm) and about 1.5 millimeters (mm).

The container 102 can be formed of any suitable materials. In some aspects, the container 102 can be formed of resin materials such as polypropylene, clarified polypropylene, and/or high density polyethylene (HDPE), but any suitable plastic can be used. As such, suitable plastics will typically be lightweight and allow for decoration, such as pressure sensitive labeling, heat transfer, silk screen, direct off-set printing, shrink-sleeving, or in-mold labeling. The container can be any color, such as white, blue, black, green, orange, clear/colorless, or any other color. The container 102 can be formed using any suitable techniques, which may include injection molding, blow molding, and/or 3-D printing. The containers can be molded in a mono-layer or in multiple layers.

Moreover, the container 102, such as is shown in FIG. 5, can have a child resistant lock 106 or portions thereof disposed directly on the container 106 and can be configured to mate with corresponding features on an enclosure. For example, FIG. 5 illustrates a child resistant lock 106 that is a sliding lock that can move along the path of either arrow A or arrow B, or both and is configured to mate with corresponding surface features on or in an enclosure. Alternatively or additionally, the container 102 can have a series of protrusions—such as outwardly extending tabs—or recesses—such as slots or holes—that mate with the enclosure to form a child resistant lock 106.

The enclosure 106 can be any suitable dimension and shape and can include various surface features including but not limited to tamper-evident or tamper-proof components, child resistant components, and decorative features. As shown in FIG. 3, the enclosure 106 can have a height H2, a length L3, and a width W2. In some aspects, the enclosure can include tamper-evident or tamper-proof mechanisms, such as a tamper-proof pull tab 109.

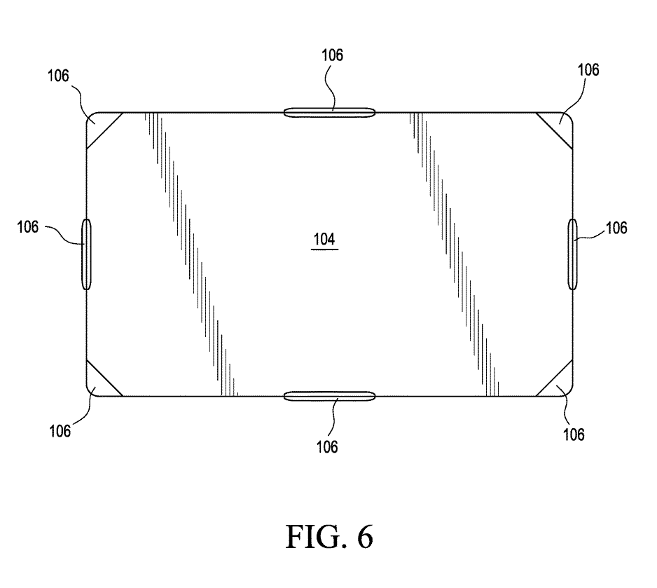

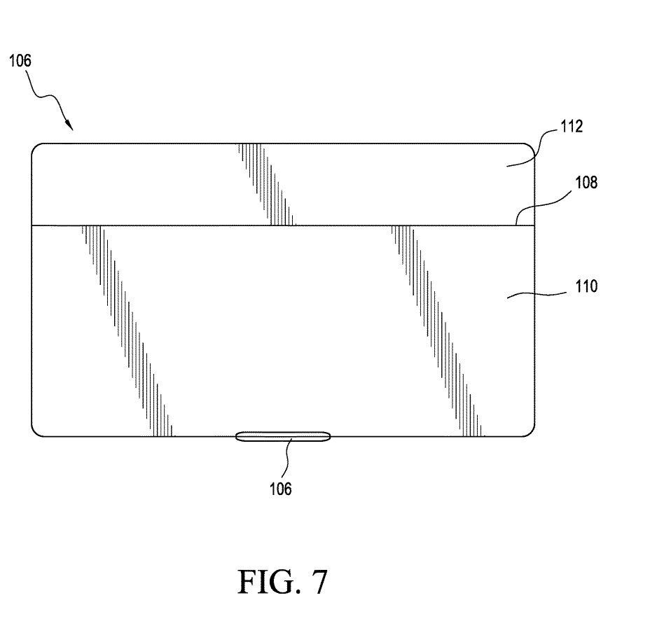

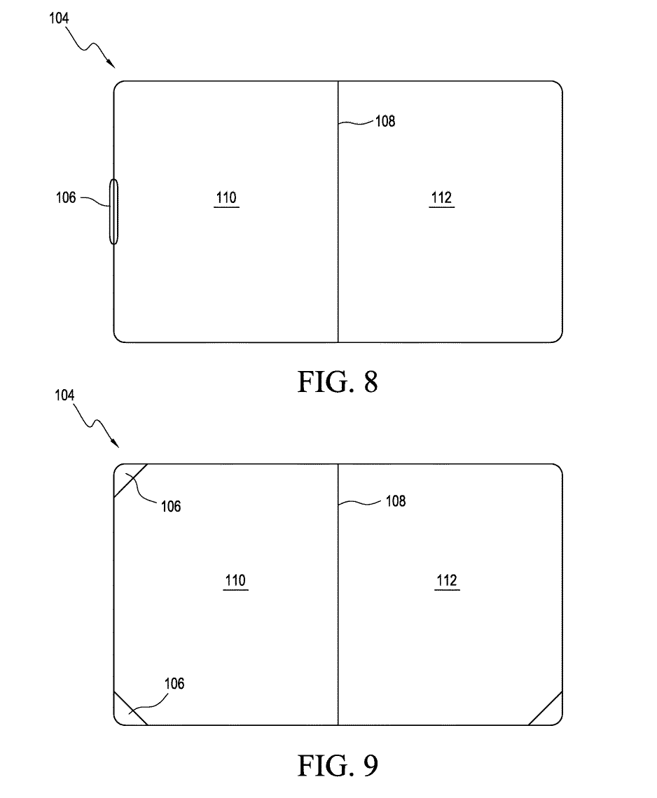

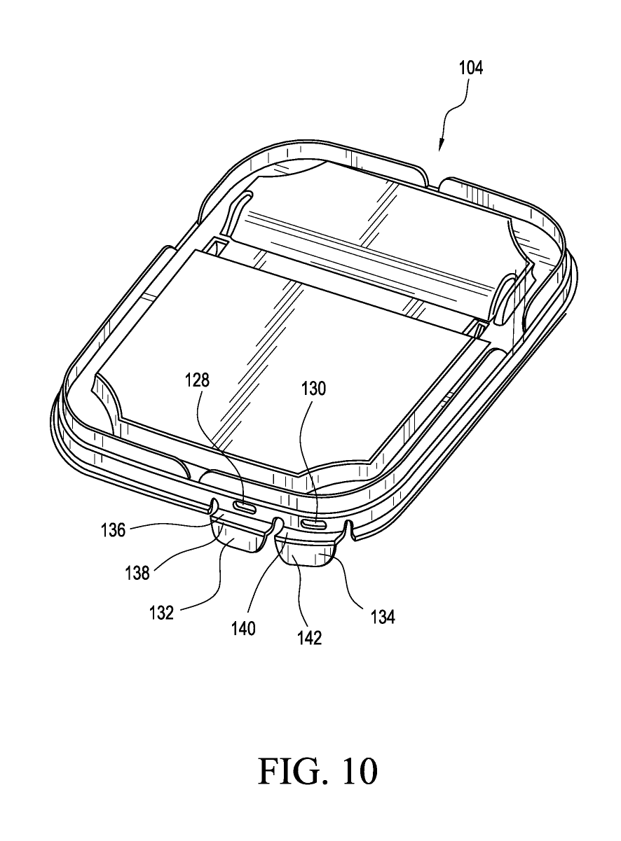

FIGS. 6-10 illustrate example enclosures 104. FIG. 6 is a top-down view of an enclosure 104. FIG. 7 is a top-down view of an example enclosure 104. FIG. 8 is a top-down view of an example enclosure 104. FIG. 9 is a top-down view of an example enclosure 104. FIG. 10 is a perspective view of an example enclosure 104. In some aspects, the enclosure 104, as mentioned above, includes a child resistant lock or mechanism 106, which can be placed in any suitable location on the enclosure 104. For example, the child resistant lock 106 can be placed anywhere along the rim or periphery of the enclosure 104, such as at an end 114 of the enclosure 106, at a corner 116 of the enclosure 104, and/or along a side 118 of the enclosure 104. Additionally or alternatively, the child resistant mechanism 106 can be placed in a central, non-peripheral portion of the enclosure 104.

Additionally, as will be disclosed in more detail below, the child resistant lock 106 and/or portions thereof may be formed of any suitable locking mechanism and may be formed either directly on the enclosure, directly on the container, or combinations thereof. In some aspects, for example, the child resistant lock 106 may include either a male or female mating portion on the enclosure 104, such as a recess that mates with a corresponding protrusion disposed on the container 102, or vice versa. For example, the enclosure 106 can contain a sliding mechanism that mates with one or more protrusions and recesses formed on the top edge of the container 102. Alternatively, a sliding mechanism can be disposed on the container and configured to mate with a portion of the enclosure. Alternatively, a series of protrusions and recesses, i.e., tabs and slots can be used.

As described, any suitable child resistant lock or mechanism can be used. As used herein “child resistant” means a packaging mechanism that protects against the accidental ingestion of chemicals by children younger than about five years of age. In some aspects, mechanisms that are child resistant are also “senior-friendly.” “Senior-friendly,” as used herein means a packaging mechanism that is able to be opened by elderly or senior citizens. Child resistant and senior friendly packaging and/or mechanisms (collectively referred to as “CR” or “CRP”) are regulated by various government institutions and regulations. For example, under the Federal Insecticide, Fungicide, and Rodenticide Act (FIFRA), section 25 (c)(3), the Environmental Protection Agency (EPA) sets standards for the packaging of pesticides and/or devices to protect children and adults from serious illness or injury resulting from accidental ingestion or contact with these pesticides or devices. For example, the EPA requires that packaging comply with the CRP standards as stated in 40 CFR 157.32—Effectiveness Standard—and that CRP tested by the protocol in 16 CFR 1700.20 shall meet the effectiveness specifications in 16 CFR 1700.15(b). Moreover, the Consumer Product Safety Commission (CPSC) administers the Poison Prevention Packaging Act of 1970 (PPPA), 15 U.S.C. §§1471-1476, which regulates household products. Regulations issued under the PPPA provide for CR packaging on many household products in order to prevent children under the age of five years old from gaining access to those household products that could cause serious illness or injury. Many suitable types of CR mechanisms exist and are defined and categorized by the CPSC and by ASTM International. ASTM classifications are defined at ASTM D3475-09, and include:

ASTM Type I Reclosable Packaging Continuous Thread Closure;

ASTM Type II Reclosable Packaging Lug Finish Closure;

ASTM Type III Reclosable Packaging Snap Closure;

ASTM Type IV Unit Non Reclosable Packaging Flexible (Strip/Pouch);

ASTM Type VII Aerosol Packages;

ASTM Type VIII Non Reclosable Packaging Semi Rigid (Blister);

ASTM Type IX Dispensers (Not Intended To Be Removed);

ASTM Type X Box Or Tray Package;

ASTM Type XI Reclosable Packaging Flexible; and

ASTM Type XIII Reclosable Packaging Semi Rigid (Blister).

Additional examples, classifications, and standards are found at ASTM D3475-15. In some aspects, any suitable ASTM D3475-09 or ASTM D3475-15 defined CR mechanisms may be utilized in the child resistant lock 106. The child resistant lock 106 can be any CR mechanism that meets or otherwise passes at least one of these standards or regulations and can be, for example, a sliding lock, a depressible tab or tabs, or any other suitable child resistant mechanism. For example, and without limitation, example child resistant mechanisms are shown in U.S. Pat. No. 8,839,975 and U.S. Pat. No. 6,983,859, which are hereby incorporated by reference for their teachings of child resistant locking mechanisms only. Additional child resistant locking mechanisms are described in U.S. Publication No. 2013/0186887, which is hereby incorporated by reference.

FIG. 10 illustrates portions of one such example child resistant lock. As shown, components of a child-resistant lock 106 can be located an outer periphery of the enclosure 104. The aforementioned components may include a plurality of slots 128, 130 placed in a corresponding position along the enclosure 104 periphery to coincide with corresponding protrusions in the container 102 when the enclosure 104 is assembled to container 102. In some aspects, a plurality of flexible tabs 132, 134 can extend from the periphery of the enclosure 104. Flexible tab 132 can be formed from a portion 136 extending from a location slightly below slot 128, and a portion 138 extends downwardly therefrom. Flexible tab 134 is formed from a portion 140 extending from a location slightly below slot 130, and a portion 142 extends downwardly therefrom. In some aspects, downwardly extending flexible tabs may pivot with respect to the body of the enclosure 104, thereby dislodging protrusions received from the container 102.

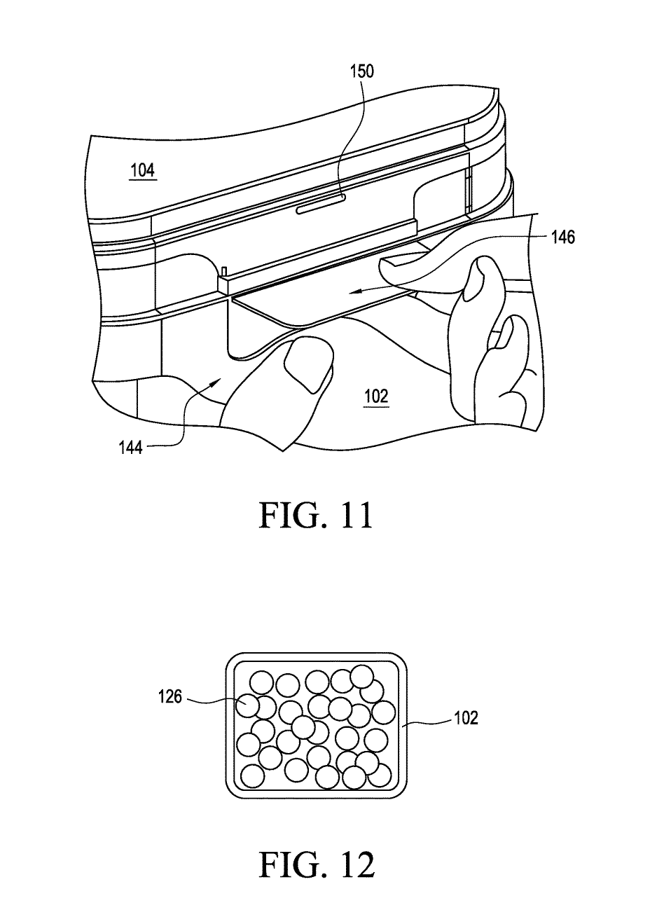

FIG. 11 illustrates another example child resistant lock 106 and the steps of opening the container and enclosure. As shown in FIG. 11, a method of opening a container 102 includes first pressing a lever guard 144 toward the container 102, thereby creating access to a pull lever 146. Second, the method includes pulling the pull lever 146 via the created access. The action of pulling the pull lever 146 thereby lifts a lift tab, thereby displacing the enclosure 102 covering an opening of the container 102. Finally, the enclosure 104 may be lifted from the container 102.

As such, the method of opening the container 102 and enclosure 104 requires strength for overcoming the resistance at the container tooth (not shown) and tooth slot 150, and dexterity for pressing the lever guard 144 while lifting the pull lever 146, and logic for understanding the sequence of steps to open the container 102 and enclosure 104. Accordingly, the container 102 and enclosure 104 combines these elements to provide for an effective child resistant closure.

Additionally, as shown in FIGS. 6-10, the enclosure 104 can include a hinge 108. As shown, the hinge 108 can be operatively coupled to a first flap or portion 110 of the enclosure 104 and a second flap or portion 112 of the enclosure 104 such that the first flap or portion 110 is pivotable relative to the second flap 112. As shown in FIGS. 7-9, the hinge 108 can be placed in any location along an axis of the enclosure 104 and can either extend lengthwise, as shown in FIG. 7, or widthwise as shown in FIGS. 8-9. Any suitable hinge mechanism can be used.

The enclosure 104 can be formed of any suitable materials. In some aspects, the enclosure 104 can be formed of resin materials such as polypropylene, clarified polypropylene, and/or high density polyethylene (HDPE), but any suitable plastic can be used. As such, suitable plastics will typically be lightweight and in some aspects can allow for decoration, such as pressure sensitive labeling or in-mold labeling. The enclosure can be any color or color affect, such as white, blue, black, green, orange, clear/colorless, or any other color. Color affects may include pearlescent, iridescent or metallic affects. The enclosure 104 can be formed using any suitable techniques, which may include injection molding, blow molding, and/or 3-D printing. In some aspects, the enclosure 104 can be formed in situ with the container 102 and can be integrally formed with the container. Alternatively, the enclosure 104 can be formed separately from the container 102 and be assembled, i.e. secured, to the container 102 either before or after the container 102 is filled with a chemical. Additionally, the enclosure 104 and/or container 102 can have an inner membrane (not shown) such as to provide tamper evidence and/or prevent chemical leakage during shipping.

FIG. 12 illustrates a top-down view of a container 102 with a chemical 126 having no secondary packaging disposed within the container. In use, the lightweight chemical packaging device 100 is configured to contain a chemical 126, such as a pool chemical, within the container 102 such that the chemical is stored or disposed without any additional packaging, such as child resistant packaging or other secondary packaging. That is, the pool chemical pellets, discs, briquettes, or other formulation are not individually wrapped but rather are stored in bulk within the lightweight pool chemical packaging device 100. As such, the lightweight pool chemical packaging device 100 substantially eliminates waste from the packaging system as individual child resistant wrapping is eliminated.

For example, in some aspects, a method of packaging a hazardous chemical can include filling a non-cylindrical container having a bottom, a side wall, and an opening with a hazardous chemical that is free of child resistant packaging within the container, such as is disclosed above. The method can further include enclosing the opening of the container with an enclosure having a child resistant lock configured to selectively secure the enclosure to the container such that the container can be selectively opened. In such a method, any suitable filling and/or lidding equipment or apparatus may be used. For example, a user can place the container on a scale and scoop product into the container until a desired weight is achieved. Filling and lidding may be accomplished automatically, manually or in a combination method. Alternatively, automated methods, including augers, elevators, and any other solid handling equipment can be utilized. Additionally or alternatively, in some aspects a bulk inner or secondary bag, pouch or liner can be used to aid the filling process. The inner or secondary package may or may not be securely closed. Secondary package may be sealed by various means. For example: heat sealing, twist tie, cable tie, tying inner liner in a knot, slider zipper, press to close (zip lock).

In addition to providing child resistant packaging, the lightweight container provides reduced material use in the construction of the device. This is due, in part, to the reduced thickness of the container walls and due to the lack of any secondary packaging—such as child resistant packaging—on the interior of the container.

The descriptions of the various aspects and/or embodiments of the present disclosure have been presented for purposes of illustration, but are not intended to be exhaustive or limited to the aspects and/or embodiments disclosed. Many modifications and variations will be apparent to those of ordinary skill in the art without departing from the scope and spirit of the described aspects and/or embodiments.

What is claimed is:

1. A lightweight pool chemical packaging device, comprising:
a non-cylindrical container having a bottom, a side wall, and an opening;
an enclosure having a child resistant lock configured to selectively secure the enclosure to the container such that the container can be selectively opened; and
a pool chemical that is free of child resistant packaging disposed within the container.

2. The pool chemical packaging device of claim 1, wherein the pool chemical is free of secondary packaging within the container.

3. The pool chemical packaging device of claim 1, wherein at least one of the side wall or bottom has a gauge that is between about 50 mil and about 15 mil.

4. The pool chemical packaging device of claim 1, wherein the container has a volume between about one-half gallon and about 2 gallons.

5. The pool chemical packaging device of claim 1, wherein a portion of the child resistant lock is disposed on the enclosure and a portion of the child resistant lock is disposed on the container.

6. The pool chemical packaging device of claim 1, wherein the child resistant lock comprises an interlocking component that is configured to mate with a corresponding interlocking component of the container.

7. The pool chemical packaging device of claim 1, wherein the enclosure further comprises a first flap, a second flap, and a hinge separating the first and second flap.

8. The pool chemical packaging device of claim 1, wherein the pool chemical is calcium hypochlorite, dichloro-s-triazinetrione, trichloro-s-triazinetrione, or polyhexamethylene biguanide.

9. The pool chemical packaging device of claim 1, wherein the pool chemical is a tablet, disk, stick, briquette, or inner unitized package.

10. A chemical packaging system, comprising:
a lightweight, non-cylindrical container having a bottom, a side wall, an opening, an enclosure, and a child resistant lock configured to selectively secure the enclosure to the container such that the container can be selectively opened; and
a hazardous chemical that is free of child resistant packaging disposed within the lightweight container.

11. The chemical packaging system of claim 10, wherein the lightweight container has a volume between about one-half gallon and about 2 gallons.

12. The chemical packaging system of claim 10, wherein the side wall has a gauge that is between about 50 mil and about 15 mil.

13. The chemical packaging system of claim 10, wherein the bottom has a gauge that is between about 50 mil and about 15 mil.

14. A method of packaging a hazardous chemical, comprising:
filling a non-cylindrical container having a bottom, a side wall, and an opening with a hazardous chemical that is free of child resistant packaging within the container; and
enclosing the opening of the container with an enclosure having a child resistant lock configured to selectively secure the enclosure to the container such that the container can be selectively opened.

15. The method of packaging a hazardous chemical of claim 14, wherein the hazardous chemical is a pool chemical.

16. The method of packaging a hazardous chemical of claim 15, wherein the pool chemical is calcium hypochlorite, dichloro-s-triazinetrione, trichloro-s-triazinetrione, or polyhexamethylene biguanide.

17. The method of packaging a hazardous chemical of claim 14, wherein the hazardous chemical is a tablet, disk, stick, briquette, or inner unitized package.

18. The method of packaging a hazardous chemical of claim 14, wherein the side wall has a gauge that is between about 50 mil and about 15 mil.

19. The method of packaging a hazardous chemical of claim 14, wherein the bottom has a gauge that is between about 50 mil and about 15 mil.

20. The method of packaging a hazardous chemical of claim 14, wherein the container has a volume between about one-half gallon and about 2 gallons.
